(19) United States
(12) Patent Application Publication
(10) Pub. No.: US 2013/0336283 A1
(43) Pub. Date: Dec. 19, 2013

(54) OVERLOAD CONTROL IN MOBILITY MANAGEMENT ENTITY

(71) Applicants: Curt Wong, Sammamish, WA (US); Devaki Chandramouli, Plano, TX (US)

(72) Inventors: Curt Wong, Sammamish, WA (US); Devaki Chandramouli, Plano, TX (US)

(73) Assignee: Nokia Siemens Networks Oy, Espoo (FI)

(21) Appl. No.: 13/524,138

(22) Filed: Jun. 15, 2012

(51) Int. Cl. H04W 36/00

(52) U.S. Cl. 370/331

(57) ABSTRACT

Communication systems, such as wireless telecommunication systems, can benefit from enhancements related to overload situations. For example, communication systems that include a mobile management entity may benefit from methods and devices for overload control in a mobility management entity. For example, a method can include detecting a first overload condition in a mobility management entity. The method can also include determining offloading of at least one user equipment from the mobility management entity to an alternative radio access technology based, at least in part, on the first overload condition.

### BACKGROUND

1. Field

Communication systems, such as wireless telecommunication systems, can benefit from enhancements related to overload situations. For example, communication systems that include a mobile management entity may benefit from methods and devices for overload control in a mobility management entity.

2. Description of the Related Art

The evolved packet system (EPS), the successor of general packet radio system (GPRS), provides radio interfaces and packet core network functions for broadband wireless data access. EPS core network functions include the mobility management entity (MME), the packet data network gateway (PDN-GW) and the Serving Gateway (S-GW). An example of an evolved packet core (EPC) architecture is illustrated in FIG. 1 and is described by third generation partnership project (3GPP) technical specification (TS) 23.401, which is incorporated herein by reference in its entirety. A common packet domain core network can be used for both radio access networks (RANs), the global system for mobile communication (GSM) enhanced data rates for GSM evolution (EDGE) radio access network (GERAN) and the universal terrestrial radio access network (UTRAN).

As shown in FIG. 2, the evolved packet core may be provided in connection with non-third generation partnership project (3GPP) access networks, as described by 3GPP TS 23.402. For example, the non-3GPP access network can be a high rate packet data (HRPD) access network (AN) with an HRPD serving gateway (HSGW). Moreover, second generation (2G)/third generation (3G) radio access technology (RAT) can be served by a serving general packet radio service (GPRS) support node (SGSN) or Mobile Switching Center (MSC) while long term evolution (LTE) is served by MME.

Similarly for operator with LTE and non-3GPP RATs (e.g., CDMA 2000), these multi-modes UE will most likely be camping to LTE as much as possible as well. The following figure shows the EPS with non 3GPP access (e.g., CDMA2000).

A multimode user equipment (UE), such as one that can operate in 2G, 3G, and LTE or one that can operate in high rate packet data HRPD and LTE, may camp on LTE access. For example, LTE access may be the preferred access from the UE's standpoint. Thus, a mobility management entity (MME) will get overloaded while the other RATs that are handled by SGSN or HRPD access network (AN) are underutilized. SGSN or HRPD AN can, for example, refer to the core and its related radio network elements that provide service to the UE in that RAT.

Conventionally, when an MME gets overloaded, it sends a back off timer message to a UE, to prevent the UE from accessing LTE for a certain period of time. Thus, during this time, the UE will not get any services.

Alternatively, if a UE tries to access LTE and if it gets a network access stratum (NAS) rejection message five times, the UE is free to reselect to another radio access technology (RAT) or another public land mobile network (PLMN). The UE, therefore, will have to wait for five such rejections, including any back off period(s), before it can re-select to other non-3GPP RAT.

Moreover, the other RAT that is served by the SGSN/HRPD AN or the SGSN/HRPD AN itself may also be in an overload condition. If so, the UE may go back and forth between RATs without getting service, but generating additional traffic in both networks while attempting to get service.

Furthermore, multimode user equipment (UE) may require both EPS and non-EPS (CS—voice, SMS) services. Such UE(s) may try to camp on LTE access and also obtain CS services offered by MSC. If the mobility management entity (MME) is overloaded while the MSC is not (e.g. when the MSC is underutilized), then the UE may not be able to obtain both CS and PS services despite the fact MSC is available to provide services.

### SUMMARY

According to certain embodiments, a method includes detecting a first overload condition in a mobility management entity. The method also includes determining offloading of at least one user equipment from the mobility management entity to an alternative radio access technology based, at least in part, on the first overload condition.

In certain embodiments, an apparatus includes at least one processor and at least one memory including computer program code. The at least one memory and the computer program code are configured to, with the at least one processor, cause the apparatus at least to detect a first overload condition in a mobility management entity. The at least one memory and the computer program code are also configured to, with the at least one processor, cause the apparatus at least to determine offloading of at least one user equipment from the mobility management entity to an alternative radio access technology based, at least in part, on the first overload condition.

A non-transitory computer-readable medium, according to certain embodiments, is encoded with instructions that, when executed in hardware, perform a process. The process includes detecting a first overload condition in a mobility management entity. The process also includes determining offloading of at least one user equipment from the mobility management entity to an alternative radio access technology based, at least in part, on the first overload condition.

An apparatus, in certain embodiments, includes detecting means for detecting a first overload condition in a mobility management entity. The apparatus also includes determining means for determining offloading of at least one user equipment from the mobility management entity to an alternative radio access technology based, at least in part, on the first overload condition.

### BRIEF DESCRIPTION OF THE DRAWINGS

For proper understanding of the invention, reference should be made to the accompanying drawings, wherein:

FIG. 1 illustrates an evolved packet core architecture.

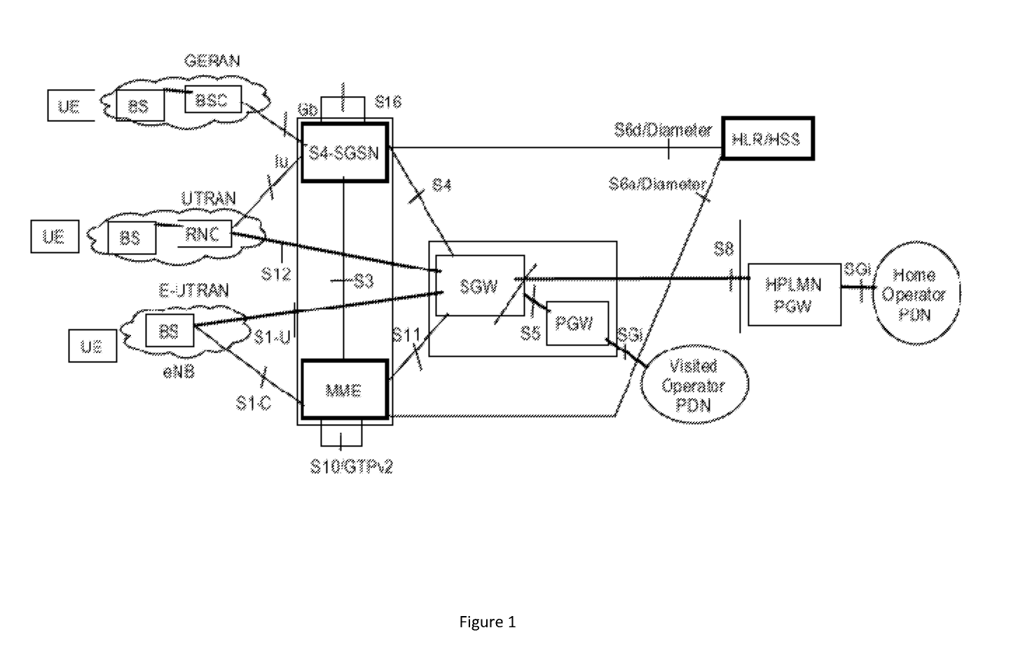

FIG. 2 illustrates an evolved packet core architecture with non-3GPP accesses.

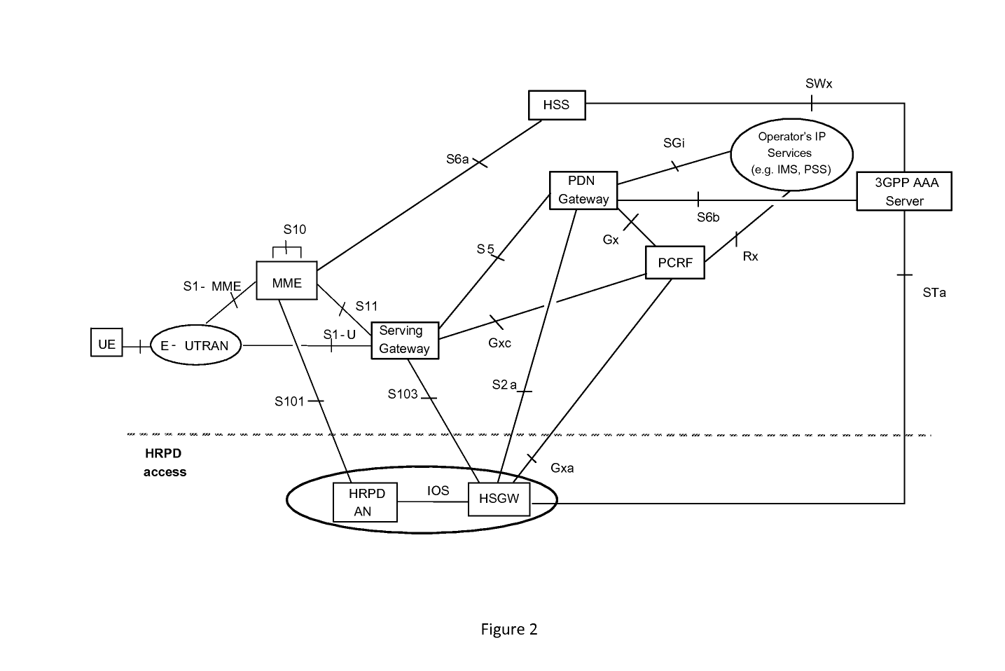

FIG. 3 illustrates a method in which a neighboring SGSN/HRPD AN is not in overload condition, according to certain embodiments.

FIG. 4 illustrates a method in which a neighboring SGSN/HRPD AN is in overload condition, according to certain embodiments.

FIG. 5 illustrates a method according to certain embodiments.

FIG. 6 illustrates a system according to certain embodiments.

FIG. 7 illustrates another method in which a neighboring SGSN/HRPD AN is not in overload condition.

### DETAILED DESCRIPTION

As mentioned above, a multimode user equipment (UE), such as one that can operate in second generation (2G), third generation (3G), and long term evolution (LTE) or one that can operate in high rate packet data (HRPD) and LTE, may camp on LTE access. For example, LTE access may be the preferred access from the UE's standpoint. Thus, a mobility management entity (MME) will get overloaded while the other RATs that are handled by SGSN or HRPD access network (AN) are underutilized.

Certain embodiments, therefore, can actively redirect one or more of these UEs to other RAT(s) until the MME is recovered from the overload. This allows the UE to continue to receive services from other RATs with non-overloading core network elements.

However, certain embodiments keep the UE in the current RAT if the network is aware that the other associated core network (CN), such as SGSN or HRPD AN, is also in overload condition. Thus, certain embodiments minimize further UE-network interaction, which could cause further overload to the network.

In certain embodiments, therefore, the MME is aware of the condition in its neighboring SGSN/HRPD AN before actively redirecting the UE to other RATs.

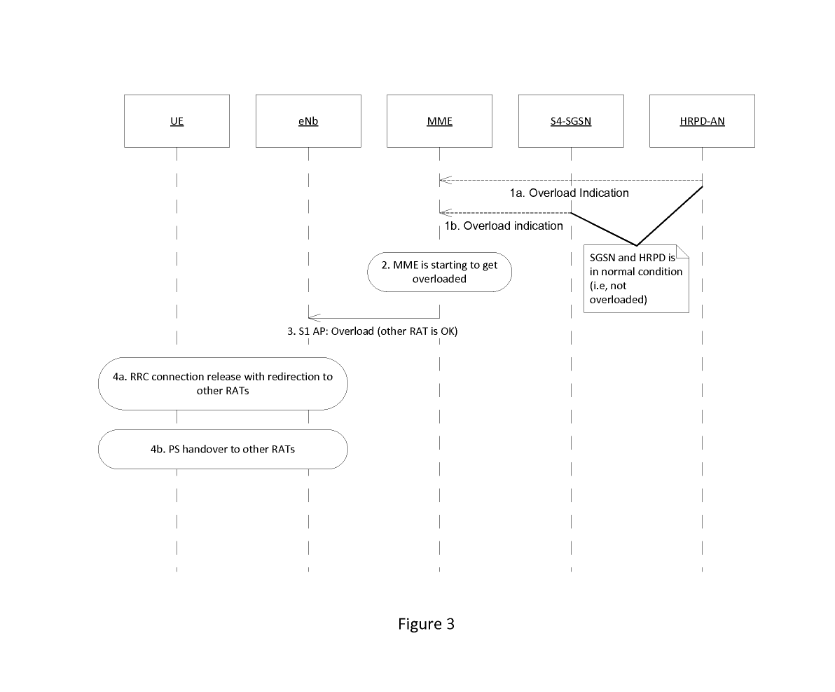

FIG. 3 illustrates a method in which a neighboring SGSN/HRPD AN is not in overload condition. As shown in FIG. 3, at 1a a neighboring HRPD-AN can abstain from sending an overload indication to a mobility management entity. Likewise, at 1b, a neighboring SGSN can abstain from sending an overload indication to the mobility management entity.

Such an indication can be sent implicitly or explicitly. For example, the indication can be sent explicitly when the SGSN or HRPD-AN is overloaded, or alternatively a “not overloaded” message can be sent whenever SGSN or HRPD-AN are not overloaded.

Moreover, the indication can be sent indirectly or directly. For example, a network management device for a heterogeneous network can identify a loading of the SGSN and HRPD-AN and transmit a single report or multiple reports to the mobility management entity. Alternatively, the overload indication can be sent directly to the mobility management entity.

In the scenario illustrated in FIG. 3, neither SGSN nor the HRPD-AN are overloaded, and explicit indications are the indication mechanism, so no message is sent. The absence of a message indicates “normal mode” for these networks.

At 2, the MME can detect that it is itself starting to get into an overload condition. Therefore, at 3, the MME can send an overload indication to the eNB with an indication that other RATs are ok for offload purpose. The indication that other RATs are ok can be general or specific. In other words, the indication can specify which RATs are ok, or it can specify generally that it is ok to use other RATs.

Additionally, not shown, the MME can send indications to the SGSN and/or HRPD-AN indicating that the MME is overloaded. In certain embodiments, this message can serve as a query requesting an overload status of the SGSN and HRPD-AN. In another alternative, the MME can send an indication to a network management device. The network management device can be a device for managing one or more networks. For example, the network management device can be configured to balance network load in, for example, a heterogeneous network

Moreover, as an alternative to the order of steps as shown, the MME detecting its own overload or near overload state can trigger the MME to begin monitoring regarding the status of neighboring access networks. Thus, the MME does not need to monitor the overload status of other networks before the MME has determined that it is within a predetermined threshold of own overload.

At 4a, the eNB can offload an active UE for the MME, using radio resource connection (RRC) connection with redirection. Alternatively, at 4b, the eNB can offload the UE for the MME, using a packet switched handover (PS-HO). Either the eNB or the MME can decide which approach is to be used in a particular case.

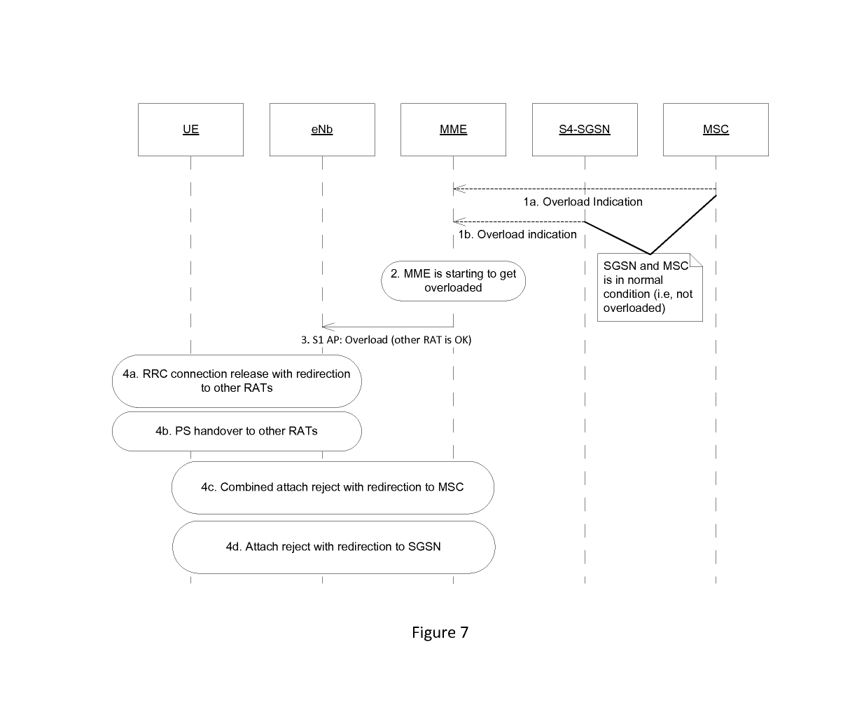

FIG. 7 illustrates another method in which a neighboring SGSN/HRPD AN is not in overload condition. Thus, at 1a and 1b, in this scenario the neighboring SGSN/MSC is not in overload condition, so the MME does not get any notification. Then, at 2, the MME starts to get into overload condition. Therefore, at 3, the MME can send an overload indication to an eNB with an indication that other RATs are ok for offload purposes.

At 4a and/or 4b, the eNb can offload the active UE for this MME using RRC connection with redirection or PS-HO. At 4c, when a UE requires non-EPS services, such as when a UE performs combined registration to receive voice and SMS services, the MME can redirect the UE to an MSC (for example, with a cause code that indicates this redirection). Alternatively, at 4d, when a UE requires EPS services, the MME can redirect the UE to an SGSN (for example, with a cause code that indicates this redirection).

Thus, when the MME determines that it is overloaded but the SGSN and/or HRPD is not overloaded, the MME can also send an indication over NAS reject message(s) (e.g. attach reject, tracking area update (TAU) reject, or the like) with a certain cause code. This cause code can indicate that the UE should not attach to LTE for a certain duration but can move to another RAT since it is underutilized.

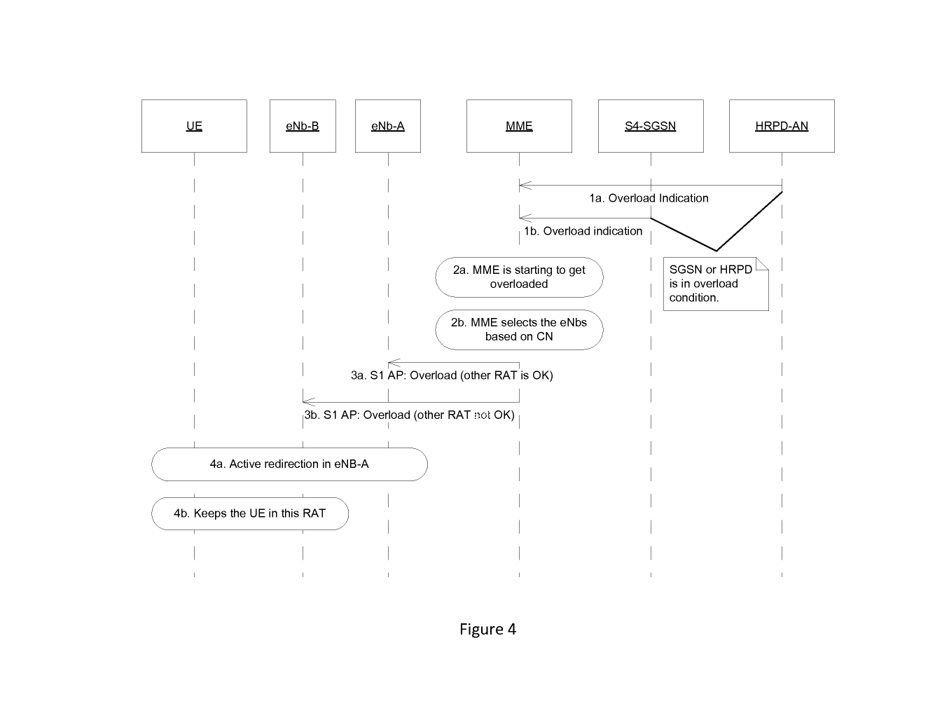

FIG. 4 illustrates a method in which a neighboring SGSN/HRPD AN is in overload condition. As shown in FIG. 4, at 1a a neighboring HRPD-AN can send an overload indication to a mobility management entity. Likewise, at 1b, a neighboring SGSN can send an overload indication to the mobility management entity.

As mentioned, above, the indication that the respective core network (CN) is overloaded can be explicit or implicit, direct or indirect.

For example, at 2a, the MME can start to get into an overload condition. The MME can have a table, provided by operation and maintenance (O&M) in which each eNB's target cells are associated with the overloaded CN. At 2b, the MME can select the eNBs based on which CN they correspond to then.

Then, at 3a, for those eNBs that are not associated with CN overload, the MME can send an overload indication that other RATs are ok for offload purpose. Likewise, at 3b, for those eNBs that have target cells associated with an overloaded CN, the MME sends an overload indication that other RATs are not ok for offload purpose.

At 4a, those eNBs which gets the “other RATs are ok” indication can actively offload the UE to other RATs. Moreover, at 4b, those eNBs which get the “other RATs are not ok” indication can continue to keep the UE in this RAT based on existing procedure.

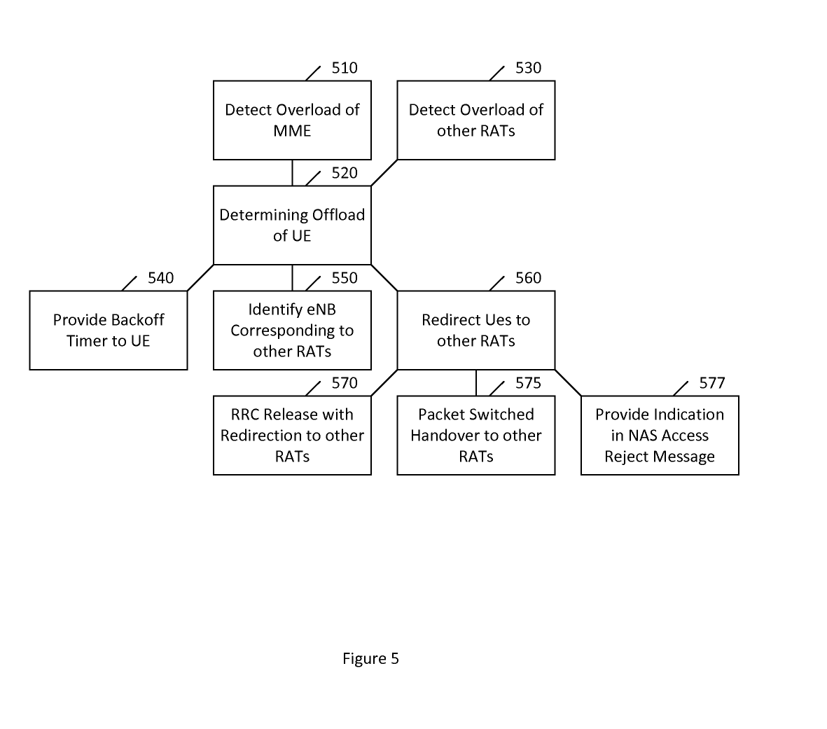

FIG. 5 illustrates a method according to certain embodiments. As shown in FIG. 5, a method can include, at 510, detecting a first overload condition in a mobility management entity.

The method can also include, at 520, determining offloading of at least one user equipment from the mobility management entity to an alternative radio access technology based, at least in part, on the first overload condition.

The determining offloading can include determining to offload the user equipment to the alternative radio access technology when the first overload condition is that the mobility management entity is overloaded. Here, “overloaded” can refer to a situation in which overload is imminent, such as when the mobility management entity is fully loaded or the loading is above a threshold, such as 80% loaded or 90% loaded.

The method can further include, at 530, detecting a second overload condition in the alternative radio access technology. The determining the offloading can be based, at least in part, on the second overload condition. For example, the determining the offloading can include determining to offload the user equipment to the alternative radio access technology when the first overload condition is that the mobility management entity is overloaded and the second overload condition is that the alternative radio access technology is not overloaded.

The determining the offloading can include determining to provide, at 540, a back off timer to the user equipment when the second overload condition is that the alternative radio access technology is overloaded. Moreover, the determining the offloading can include, at 550, identifying at least one base station, such as an eNode B, corresponding to the alternative radio access technology. These may be base stations that have overlapping coverage with an alternative radio access technology, or otherwise are associated the another radio access technology.

The method can additionally include, at 560, redirecting at least one user equipment to other radio access technologies when the first overload condition is that the mobility management entity is overloaded. The redirecting can include an indication regarding the length of the offload. In other words, the user equipment can be told a minimum waiting time before the user equipment can attempt to access the original access technology again. Moreover, the user equipment or base station can be told which specific radio access technology(ies) are to be used.

The redirecting can include performing at least one of, at 570, a radio resource control connection release with redirection to other radio access technologies or, at 575, packet switched handover to other radio access technologies or, at 577, providing an indication in the NAS access reject message.

The method of FIG. 5 can be performed by, for example, at least one of a network management device, a mobility management entity, or a base station.

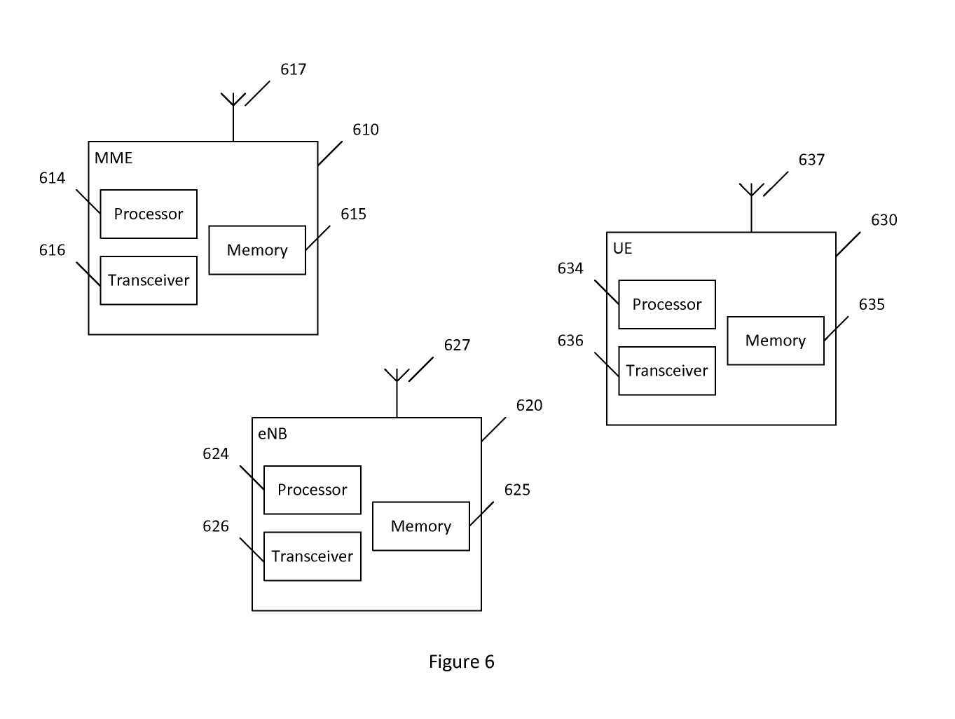

FIG. 6 illustrates a system according to certain embodiments of the invention. In one embodiment, a system may include several devices, such as, for example, mobility management entity 610, base station 620, and user equipment 630. Each of these devices may include at least one processor, respectively indicated as 614, 624, and 634. At least one memory is provided in each device, and indicated as 615, 625, and 635, respectively. The memory may include computer program instructions or computer code contained therein. Transceivers 616, 626, and 636 are provided, and each device may also include an antenna, respectively illustrated as 617, 627, and 637. Other configurations of these devices, for example, may be provided. For example, mobility management entity 610, base station 620, and user equipment 630 may be configured for wired communication, rather than wireless communication, and in such a case antennas 617, 627, and 637 would illustrate any form of communication hardware, without requiring a conventional antenna.

Transceivers 616, 626, and 636 can each, independently, be a transmitter, a receiver, or both a transmitter and a receiver, or a unit or device that is configured both for transmission and reception.

Processors 614, 624, and 634 can be embodied by any computational or data processing device, such as a central processing unit (CPU), application specific integrated circuit (ASIC), or comparable device. The processors can be implemented as a single controller, or a plurality of controllers or processors.

Memories 615, 625, and 635 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate therefrom. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as mobility management entity 610, base station 620, and user equipment 630, to perform any of the processes described above (see, for example, FIGS. 3-5 and 7). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 6 illustrates a system including a mobility management entity 610, base station 620, and user equipment 630, embodiments of the invention may be applicable to other configurations, and configurations involving additional elements, as described herein.

Certain embodiments can permit the MME to recover from overload in active manner. Furthermore, certain embodiments can ensure that other CN(s) are not in an overloaded condition before asking the eNB to redirect them to other RATs, thereby avoiding ping-pong effect.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
detecting a first overload condition in a mobility management entity; and
determining offloading of at least one user equipment from the mobility management entity to an alternative radio access technology based, at least in part, on the first overload condition.

2. The method of claim 1, wherein the determining offloading comprises determining to offload the user equipment to the alternative radio access technology when the first overload condition is that the mobility management entity is overloaded.

3. The method of claim 1, further comprising:
detecting a second overload condition in the alternative radio access technology.

4. The method of claim 3, wherein the determining the offloading is based, at least in part, on the second overload condition.

5. The method of claim 4, wherein the determining the offloading comprises determining to offload the user equipment to the alternative radio access technology when the first overload condition is that the mobility management entity is overloaded and the second overload condition is that the alternative radio access technology is not overloaded.

6. The method of claim 4, wherein the determining the offloading comprises determining to provide a back off timer to the user equipment when the second overload condition is that the alternative radio access technology is overloaded.

7. The method of claim 4, wherein the determining the offloading comprises identifying at least one base station corresponding to the alternative radio access technology.

8. The method of claim 1, further comprising:
redirecting at least one user equipment to other radio access technologies when the first overload condition is that the mobility management entity is overloaded.

9. The method of claim 8, wherein the redirecting comprises performing at least one of a radio resource control connection release with redirection to other radio access technologies or packet switched handover to other radio access technologies or indicating redirection in a network access stratum reject message with an appropriate cause code.

10. The method of claim 1, wherein the method is performed by at least one of a network management device, a mobility management entity, or a base station.

11. An apparatus, comprising:
at least one processor; and
at least one memory including computer program code,
wherein the at least one memory and the computer program code are configured to, with the at least one processor, cause the apparatus at least to
detect a first overload condition in a mobility management entity; and
determine offloading of at least one user equipment from the mobility management entity to an alternative radio access technology based, at least in part, on the first overload condition.

12. The apparatus of claim 11, wherein the at least one memory and the computer program code are also configured to, with the at least one processor, cause the apparatus at least to determine offloading by determining to offload the user equipment to the alternative radio access technology when the first overload condition is that the mobility management entity is overloaded.

13. The apparatus of claim 11, wherein the at least one memory and the computer program code are also configured to, with the at least one processor, cause the apparatus at least to detect a second overload condition in the alternative radio access technology.

14. The apparatus of claim 13, wherein the at least one memory and the computer program code are also configured to, with the at least one processor, cause the apparatus at least to determining the offloading based, at least in part, on the second overload condition.

15. The apparatus of claim 14, wherein the at least one memory and the computer program code are also configured to, with the at least one processor, cause the apparatus at least to determine the offloading by determining to offload the user equipment to the alternative radio access technology when the first overload condition is that the mobility management entity is overloaded and the second overload condition is that the alternative radio access technology is not overloaded.

16. The apparatus of claim 14, wherein the at least one memory and the computer program code are also configured to, with the at least one processor, cause the apparatus at least to determine the offloading by determining to provide a back off timer to the user equipment when the second overload condition is that the alternative radio access technology is overloaded.

17. The apparatus of claim 14, wherein the at least one memory and the computer program code are also configured to, with the at least one processor, cause the apparatus at least to determine the offloading by identifying at least one base station corresponding to the alternative radio access technology.

18. The apparatus of claim 11, wherein the at least one memory and the computer program code are also configured to, with the at least one processor, cause the apparatus at least to redirect at least one user equipment to other radio access technologies when the first overload condition is that the mobility management entity is overloaded.

19. The apparatus of claim 18, wherein the at least one memory and the computer program code are also configured to, with the at least one processor, cause the apparatus at least to redirect by performing at least one of a radio resource control connection release with redirection to other radio access technologies, a packet switched handover to other radio access technologies or indicating redirection in a network access stratum reject message with an appropriate cause code.

20. The apparatus of claim 11, wherein the apparatus comprises at least one of a network management device, a mobility management entity, or a base station.

21. A non-transitory computer-readable medium encoded with instructions that, when executed in hardware, perform a process, the process comprising:
detecting a first overload condition in a mobility management entity; and
determining offloading of at least one user equipment from the mobility management entity to an alternative radio access technology based, at least in part, on the first overload condition.
